(19) United States
(12) Patent Application Publication
(10) Pub. No.: US 2013/0107496 A1
(43) Pub. Date: May 2, 2013

(54) Socketable LED Light Bulb

(71) Applicant: Albeo Technologies, Inc., Boulder, CO (US)

(72) Inventors: Jeffrey Bisberg, Boulder, CO (US); Neil Cannon, Boulder, CO (US)

(73) Assignee: Albeo Technologies, Inc., Boulder, CO (US)

(21) Appl. No.: 13/662,021

(22) Filed: Oct. 26, 2012

Related U.S. Application Data
(60) Provisional application No. 61/551,713, filed on Oct. 26, 2011.

(51) Int. Cl. H01R 33/00; F21V 9/16; F21V 29/00

(52) U.S. Cl. 362/84; 362/650

(57) ABSTRACT

A socketable LED light bulb includes a fixture for contacting power connections of a standard light bulb socket, a stem that connects one or more LEDs with the fixture, and an electronics housing configured with at least one electronic component for regulating power supplied to the one or more LEDs. The electronics housing is along the stem between the one or more LEDs and the fixture. Another socketable LED light bulb includes a fixture for contacting power connections of a standard light bulb socket, and a power converter that transmits the output voltage to flexible circuitry to power one or more LEDs. A shell provides mechanical support for the flexible circuitry, and forms apertures through which the one or more LEDs emit light.

### CROSS-REFERENCE TO RELATED APPLICATIONS

This application claims priority to U.S. Provisional Patent Application No. 61/551,713 filed 26 Oct. 2011, which is incorporated herein by reference in its entirety.

### BACKGROUND

Certain socketable light bulbs are designed for frequent replacement due to the well-known deterioration and eventual failure of the filament. The expected short lifetime of an incandescent bulb discourages integration of additional features of any significant cost, because anything built into the bulb is discarded when the filament fails. This expectation of short lifetime has resulted in the commercial development of many socket types, for example screw type sockets sometimes referred to as “E type” or “Edison base,” as well as bayonet, pin blade, wedge type sockets and others, for various incandescent light bulbs. Also, certain accessories are configured to mount with a conventional socket to make a power connection in “daisy chain” fashion, providing a second socket for an incandescent light bulb so that the accessory need not be discarded when the light bulb fails, but such accessories take up space such that the entire light bulb plus accessory does not fit in certain applications.

### SUMMARY

In an embodiment, a socketable LED light bulb includes a fixture for contacting power connections of a standard light bulb socket, a stem that connects one or more LEDs with the fixture, and an electronics housing configured with at least one electronic component for regulating power supplied to the one or more LEDs. The electronics housing is along the stem between the one or more LEDs and the fixture.

In an embodiment, a socketable LED light bulb includes a fixture for contacting power connections of a standard light bulb socket, and a power converter that transmits the output voltage to flexible circuitry to power one or more LEDs. A shell provides mechanical support for the flexible circuitry, and forms apertures through which the one or more LEDs emit light.

### BRIEF DESCRIPTION OF DRAWINGS

The present disclosure may be understood by reference to the following detailed description in conjunction with the drawings briefly described below.

FIG. 1 is a schematic drawing of a socketable light emitting diode (“LED”) light bulb, in accord with an embodiment.

FIG. 2 is a schematic cross-section of a socketable LED light bulb in a closed configuration, in accord with an embodiment.

FIG. 3A shows an enlarged view of a portion of the socketable LED light bulb of FIG. 2.

FIG. 3B shows an enlarged view of an alternate embodiment of a portion of the socketable LED light bulb of FIG. 2.

FIG. 4 is a side elevational view of the socketable LED light bulb of FIG. 2.

FIG. 5 is a schematic cross-section of the socketable LED light bulb of FIG. 2 in an open configuration.

### DETAILED DESCRIPTION

It is noted that, for illustrative clarity, certain elements in the drawings may not be drawn to scale.

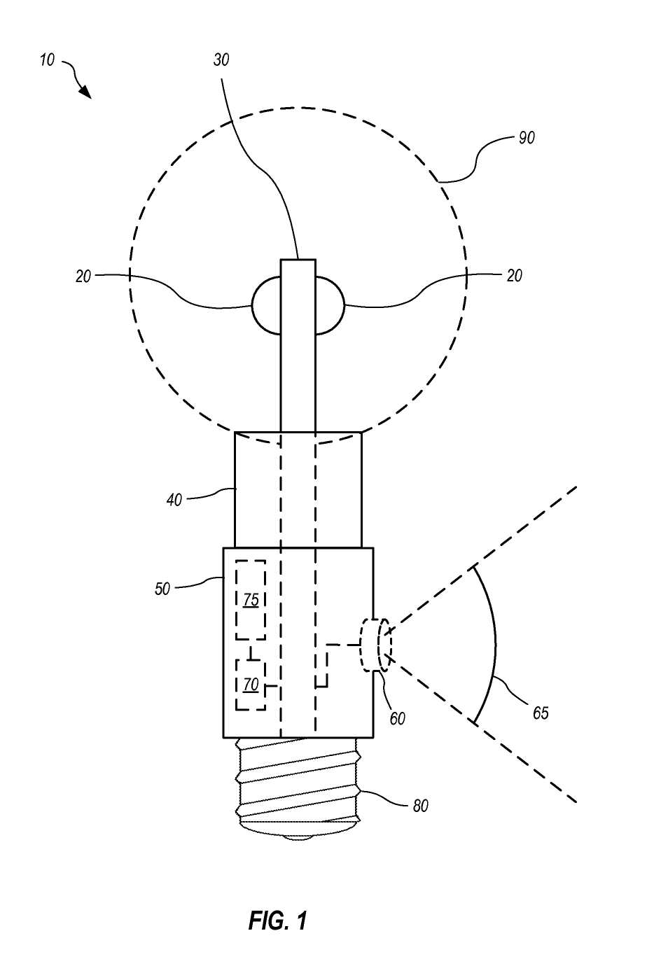

FIG. 1 is a schematic drawing of a socketable LED light bulb 10. Light bulb 10 utilizes a fixture 80 for contacting a socket (e.g., a standard Edison base or any other socket type) for compatibility with existing light bulb sockets, and mounts one or more LEDs 20 on a stem 30 connected with fixture 80. Fixture 80 screws into a socket and makes contact with power connections in the same manner as a standard socketable bulb (e.g., an incandescent Edison base bulb). Although two LEDs are shown in FIG. 1, LED light bulb 10 may have only one, or more than two LEDs. Stem 30 protrudes upwardly from fixture 80, as shown, and is less than half as wide as fixture 80, but at least three times the height of fixture 80. Stem 30 provides mechanical support for LEDs 20 and for wires (not shown) that bring electrical power from fixture 80 to LEDs 20. A heat sink 40 is in thermal communication with stem 30 in the vicinity of LEDs 20, for removal of heat from LEDs 20.

Stem 30 also provides mechanical support for an electronics housing 50 located between heat sink 40 and fixture 80. Electronics housing 50 includes one or more electronic components.

In one embodiment, the electronic components are an optional motion sensor 60 and an optional real-time clock 70 that control electrical power delivered to LEDs 20. Motion sensor 60 may, for example, turn on LEDs 20 for a predetermined period of time when motion is detected in a field of view 65. After the predetermined period expires, motion sensor 60 turns LEDs 20 off to conserve energy. Real-time clock 70 may also be utilized to regulate operation of LEDs 20. For example, real-time clock 70 may determine “day” and “night” periods, and may turn LEDs 20 on at night and off during the day. Alternatively, real-time clock 70 may determine day and night periods and may supply levels of power to LEDs 20 that are sufficient to provide a high light level during the day, and a low light level during the night (e.g., so as to avoid an unpleasantly high light level for a human whose eyes are accustomed to a low nighttime light level, as in illumination required for a tunnel through which automobiles pass).

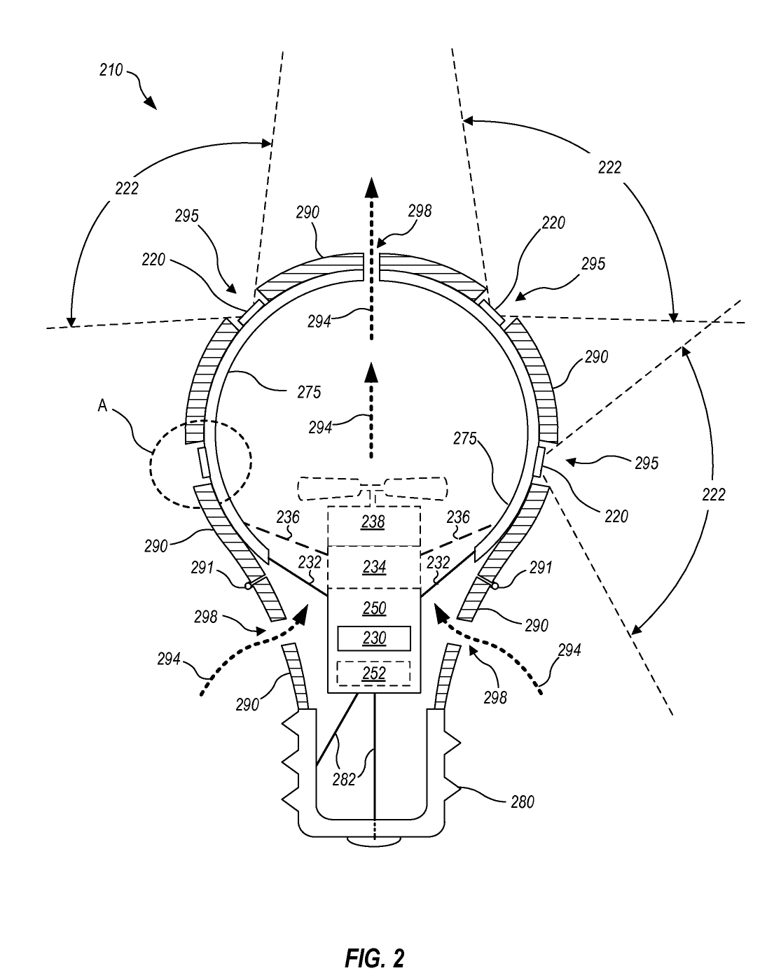

Instead of, or in addition to optional motion sensor 60 and real-time clock 70, LED light bulb 10 may include optional electronic components 75 such as, for example, orientation sensors, thermally sensitive devices, photosensors and logic devices. Thermally sensitive devices (e.g., photocouples or thermistors) may be utilized to determine temperature within the light bulb, so that the bulb may determine whether it is operating at an excessive temperature. Orientation sensors may determine orientation of a light bulb and provide information that can be utilized to initiate change(s) in the physical configuration (see, e.g., FIGS. 2-5) of light bulb 10 to improve thermal dissipation, if needed.

LED light bulb 10 may also include an optional globe 90 that mounts to stem 30 and/or heat sink 40. Globe 90 may be clear or may have a frosted finish to diffuse light from LEDs 20. Although globe 90 is shown in FIG. 1 as having a generally round shape, it is understood that globe 90 may be of any shape and size, and may be sealed or unsealed.

LEDs 20 may have much longer expected lifetimes than incandescent bulb filaments. Therefore, it is practical to include more expensive components (e.g., motion sensor 60, real-time clock 70 and optional electronic components 75) in socketable LED light bulb 10 than in filament-based light bulbs. Furthermore, LEDs 20, heat sink 40, electronics housing 50 and globe 90 are collectively small enough that they may all be integrated into an assembly that is no larger than a standard incandescent light bulb.

FIG. 2 is a schematic cross-section of a socketable LED light bulb 210 in a closed configuration. Light bulb 210 utilizes a standard fixture 280 for compatibility with existing light bulb sockets. In light bulb 210, one or more LEDs 220 mount on flexible circuitry 275, sometimes denoted as “flex” herein. Flex circuitry is, for example, easily bendable by hand, as opposed to standard epoxy glass circuit boards that are thick and rigid to the touch. An electronics housing 250 includes a power converter 230 and optional control electronics 252.

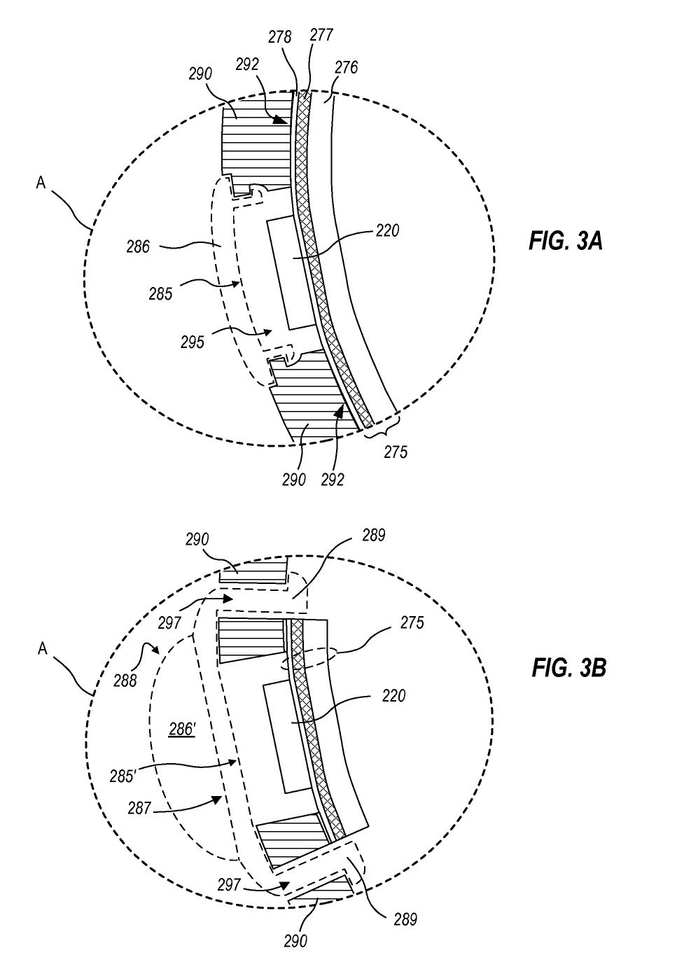

Fixture 280 couples with a standard light socket, and makes contact with power connections in the same manner as a standard incandescent (e.g., an Edison base) bulb. Power converter 230, optionally controlled by electronics 252, is electrically connected with fixture 280 through connections 282. Power converter 230 converts incoming power that is typically of at least 100 volts (e.g., 110 volts AC) to operational power at a suitable voltage and/or current for driving LEDs 220 (e.g., less than 50 volts). Power converter 230 transmits the operational power through connections 232 to flex 275. Connections 232 may be wires, for example; alternatively, flex 275 may extend to electronics housing 250 such that connections 232 are formed by flex 275 itself. LEDs 220 may mount on flex 275 by soldering, for example (see, for example, FIGS. 3A and 3B).

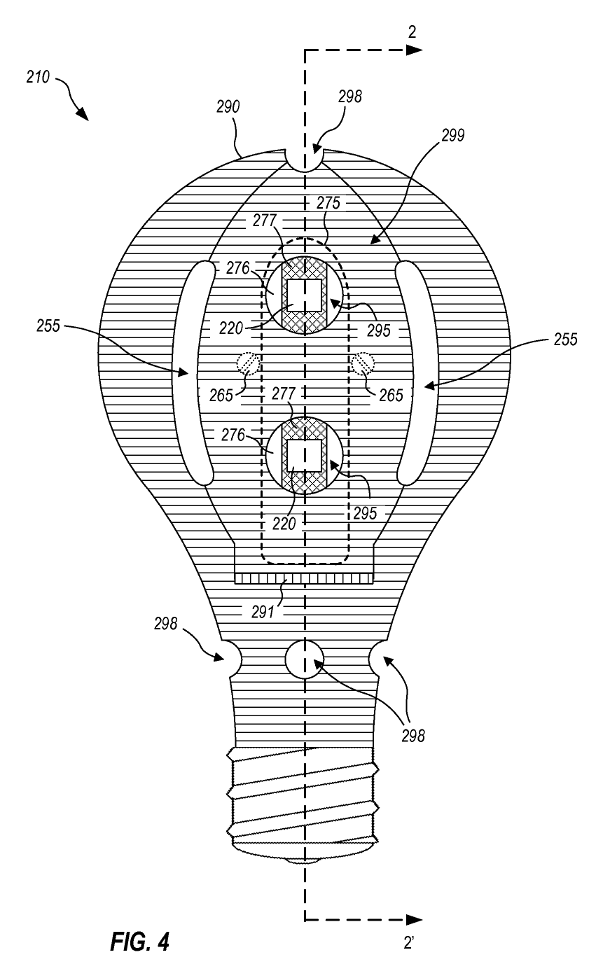

Light bulb 210 also includes a shell 290 that provides mechanical support and/or thermal dissipation for flex 275 and LEDs 220. Shell 290 may be formed, for example, of metal, thermally conductive plastic, pressed ceramic, combinations thereof and/or other materials that provide structural integrity and/or thermal dissipation. Also, portions of shell 290 may be formed of one such material and other portions may be formed of another such material (e.g., portions of shell 290 that do not move relative to fixture 280 may be formed of ceramic while movable portions (such as segments 299, FIG. 4) may be formed of metal). Shell 290 and/or components thereof may be formed, for example, by casting, injection molding, stamping and/or other known techniques. Flex 275 is positioned with respect to shell 290, (a) to align each LED 220 with an aperture 295 of shell 290, and (b) for thermal contact with shell 290, so that heat generated by LEDs 220 transfers to shell 290 for dissipation to ambient air. This is particularly advantageous when a portion of shell 290 that is in contact with flex 275 is formed of metal. Flex 275 may maintain thermal contact with shell 290 using screws (see FIG. 4) and/or adhesives (see FIG. 3A).

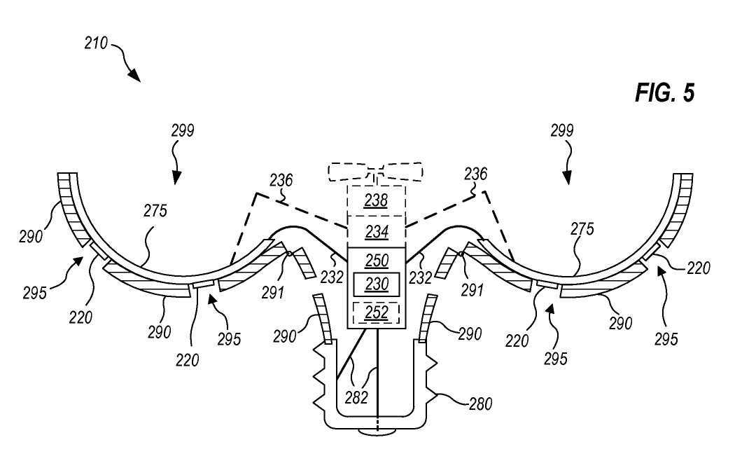

Shell 290 is shown in FIG. 2 with hinges 291 that allow portions of shell 290 to reposition (see FIG. 4 and FIG. 5). Light bulb 210 may optionally include an actuator 234 capable of moving movable portions of shell 290 through mechanical connections 236. Actuator 234 may be, for example, a motor under the control of optional control electronics 252. Shell 290 may also form vent apertures 298 that encourage air flow therethrough, as indicated by dashed arrows 294, for dissipating heat from light bulb 210. Shell 290 may form additional heat sink structures (e.g., fins or other heat radiating structures) for dissipating heat from light bulb 210. Light bulb 210 may include an optional fan 238 that increases air movement within shell 290 to promote thermal dissipation. Although shell 290 is shown in FIG. 2 with hinges 291, shell 290 may also include different interlocking and/or movable parts, or may be formed as a monolithic structure.

Optional control electronics 252 may include for example light and/or motion sensors, thermally sensitive devices, a real time clock, orientation sensors, and electronic logic. Electronics 252 may detect conditions and respond in the following, or other ways:
Detect light levels and adjust power delivered to LEDs 220 to maximize light under dark conditions, minimize light under bright conditions (or vice versa).
Detect motion and turn LEDs 220 on and off in response to detected motion.
Detect temperature of light bulb 210, and regulate operation of fan 238 to cool light bulb 210.
Detect temperature of light bulb 210, and operate actuator 234 to move segments 299 (see FIG. 4) for improved heat dissipation.
Detect orientation of light bulb 210, and operate actuator 234 to move segments 299 (see FIG. 4) to optimize light distribution, regulate operation of fan 238 to cool light bulb 210, and/or adjust power delivered to LEDs 220.
Determine date and time, and provide light at predetermined date and/or time schedules (e.g., provide light from 8:00 a.m. to 6:00 p.m. on weekdays, but suppress light on weekends).

In light bulb 210, each LED 220 emits light across a light divergence cone 222, as shown. Apertures 295 and LEDs 220 may accordingly be arranged about shell 290 so that light divergence cones 222 overlap at a distance from light bulb 210, such that LEDs 220 provide even illumination to an area surrounding light bulb 210. (Not every LED 220, aperture 295 and light divergence cone 222 are labeled, for clarity of illustration.) Although four apertures 295 and LEDs 220 are shown, it is understood that more or fewer apertures 295 and LEDs 220 may be implemented in the cross-sectional plane shown; also, FIG. 2 shows only one cross-sectional plane through light bulb 210, and other apertures 295 and LEDs 220 may be included in other cross-sectional planes through light bulb 210. That is, it is within the skill of a designer, upon reading and appreciating the present specification and drawings, to determine an appropriate number and arrangement of apertures 295 and LEDs 220 to achieve a desired light distribution, spectral output, and total light emitted from light bulb 210. Various structures that may form portion A of light bulb 210 are shown in greater detail in FIG. 3A and FIG. 3B.

FIG. 3A shows an enlarged view of certain structures forming portion A of socketable LED light bulb 210, FIG. 2. An LED 220 aligns with aperture 295 of shell 290 so as to emit light therethrough. An optional cap 286 mounts with shell 290 to provide protection for LED 220 and optionally to modify light emitted by LED 220. For example, cap 286 may be transparent or translucent, and may include materials such as coatings, pigments and/or phosphors that diffuse, refract or spectrally modify light transmitted therethrough. In particular, LED 220 may be a blue LED and cap 286 may include a phosphor coating on surface 285, or may contain phosphor incorporated into the material of cap 286, that downconverts a portion of blue LED light emitted by LED 220 to longer wavelengths.

Flex 275 includes a substrate 276 and a conductor 277 that optionally may be thicker than needed for electrical conduction, to facilitate heat transfer away from LED 220 and to shell 290. For example, standard printed circuit boards may have copper conductor thicknesses of about 0.55-1.25 oz/ft² in order to accommodate typical current requirements, and that thickness range would be sufficient to provide all the current necessary to operate LEDs 220. However, conductors 277 may have conductor thicknesses of about 2.0-2.5 oz/ft² or more to facilitate heat dissipation from LEDs 220 to shell 290. Substrate 276 may be formed of polyimide (sometimes sold under the trade name Kapton®), and conductor 277 may be a copper trace, similar to traces found in printed circuit boards. Flex 275 also includes an insulator 278 (e.g., a solder mask layer) on an outer surface of conductor 277. In the embodiment of FIG. 3A, flex 275 is held in intimate thermal contact with shell 290 using an adhesive 292 on an inner surface of shell 290; however thermal contact between flex 275 and shell 290 may also be implemented and/or improved by using fasteners such as screws (see FIG. 4) that optionally extend through flex 275 and engage a backing plate to hold flex 275 against shell 290. Insulator 278 and/or adhesive 292 are thick enough to prevent electrical contact between conductor 277 and shell 290, but thin enough to facilitate thermal transfer therebetween.

FIG. 3B shows an enlarged view of structures different from those shown in FIG. 3A, forming an alternate embodiment of portion A of socketable LED light bulb 210, FIG. 2. An optional cap 286 illustrated in FIG. 3B may be utilized by making appropriate modifications to shell 290 and/or flex 275, as discussed below. FIG. 3B shows LED 220 aligned with aperture 295 of shell 290, as in FIG. 2, and shows optional cap 286′ that mounts with shell 290. As shown in FIG. 3B, an outer surface 287 of cap 286′ includes an optional lens portion 288 that spreads light from LED 220 into a larger light divergence cone, but when lens portion 288 is omitted, outer surface 287 may be flat. Cap 286′, with or without lens portion 288, may be transparent or translucent, and may include materials such as coatings, pigments and/or phosphors that modify light transmitted therethrough.

As also shown in the embodiment of FIG. 3B, cap 286 includes flanges 289 that snap into corresponding apertures 297 in shell 290. Flex 275 may be omitted in the vicinity of flanges 289, as shown, but in alternate embodiments, flex 275 may be present and flanges 289 may be correspondingly altered so as to secure all of cap 286, shell 290 and flex 275 together, improving thermal contact between flex 275 and shell 290. Alternatively, in other embodiments, in place of flanges 289, cap 286 may form threaded elements that secure cap 286 to shell 290 by means of a backing nut that also secures flex 275. In still other embodiments, apertures 297 of shell 290 and flanges 289 of cap 286 are omitted and cap 286 is fastened to shell 290 using an adhesive.

FIG. 4 is a side elevational view of socketable LED light bulb 210 in a closed configuration. A dashed line 2-2′ indicates the cross-sectional plane of light bulb 210 that is shown in FIG. 2. FIG. 4 shows that shell 290 includes a segment 299 with which at least a portion of flex 275 mounts (flex 275 is shown in dashed outline behind segment 299). Two apertures 295, each exposing one LED 220 and portions of substrate 276 and conductor 277 of flex 275 (see FIG. 3A) are shown in FIG. 4. Also visible in FIG. 4 are two apertures 255 formed by shell 290 at edges of segment 299. Apertures 255 are examples of features that may be formed by shell 290 to further encourage air convection around and/or through light bulb 210 to improve heat dissipation.

FIG. 4 also shows two optional screws 265 that fasten flex 275 to segment 299. Although screws 265 are shown in connection with segment 299, it is understood that screws 265 may optionally be utilized in connection with any portion of shell 290 to promote thermal contact between flex 275 and shell 290. Flex 275 may be configured with electrically inactive portions that receive screws 265 on the inner surface of shell 290, or such screws may extend through flex 275 and be received by nuts or backing plates, as discussed above.

FIG. 5 is a schematic cross-section of socketable LED light bulb 210 in an open configuration. The open position shown in FIG. 5 may promote either or both of (1) targeted light distribution and (2) enhanced heat dissipation. As shown, segments 299 (see FIG. 4) of shell 290 open at hinges 291, operated by actuator 234 through mechanical connections 236. It is noted that portions out of the plane 2-2′ shown in FIG. 4 are not shown in FIG. 5. LEDs 220 in such portions of light bulb 210 may remain in their original positions, so that some light from the LEDs that remain in their original positions is emitted laterally while light from the LEDs in segments 299 primarily emit light downwards. The open configuration of FIG. 5 may be useful, for example, in a reading lamp with lampshade, in which laterally emitted light is scattered by the lampshade, while light from LEDs 220 in segments 299 is emitted downwards, towards reading material. The open configuration shown in FIG. 5 also spreads out the heat-generating LEDs 220 and opens up shell 290 such that heat dissipates directly from the LEDs 220 in segments 299, instead of concentrating such heat in the smaller space of shell 290 in the closed configuration. Also, the open configuration of shell 290 in FIG. 5 may provide significantly greater air flow within and around shell 290 than in the closed configuration shown in FIG. 2. Both the spreading of the heat-generating LEDs 220 and the improved airflow of the open configuration improve heat dissipation of LED light bulb 210.

The changes described above, and others, may be made in the socketable LED light bulbs described herein, without departing from the scope hereof. For example,
Elements described herein may be different in appearance from the schematic representations in the drawings;
Electrical connections among elements such as LEDs 20 and 220, power converters 230, motion sensors 60, real time clocks 70, optional electronic components 75 and actuators 234 may be different from the connections shown in the drawings;
Mechanical connections among elements such as globe 90 and/or shell 290 (including segments 299), stem 30, heat sink 40, electronics housings 50 and 250, fixtures 80 and 280 and actuators 234 may be made in different manner and appearance from the connections shown in the drawings.
The mechanical and optical features demonstrated in FIGS. 3A and 3B may be substituted one for another where compatible, as matters of design choice for particular applications.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A socketable LED light bulb, comprising:
a fixture for contacting power connections of a standard light bulb socket;
a stem connecting one or more LEDs with the fixture; and
an electronics housing configured with at least one electronic component for regulating power supplied to the one or more LEDs, the electronics housing disposed along the stem between the one or more LEDs and the fixture.

2. The LED light bulb of claim 1, further comprising a heat sink disposed along the stem and configured to dissipate heat from the one or more LEDs.

3. The LED light bulb of claim 2, further comprising a globe that mounts to at least one of the stem and the heat sink.

4. The LED light bulb of claim 1, wherein the at least one electronic component comprises one of a motion sensor and a real-time clock.

5. The LED light bulb of claim 1, wherein a real-time clock cooperates with a motion sensor to regulate the power supplied to the one or more LEDs.

6. A socketable LED light bulb, comprising:
a fixture for contacting power connections of a standard light bulb socket;
a power converter that transmits power from the power connections to flexible circuitry, to power one or more LEDs; and
a shell that provides mechanical support for the flexible circuitry, the shell forming apertures through which the one or more LEDs emit light.

7. The LED light bulb of claim 6, the shell comprising metal, the flexible circuitry being in thermal contact with each of the one or more LEDs and metal of the shell, thereby promoting heat dissipation from the one or more LEDs to the metal.

8. The LED light bulb of claim 6, the flexible circuitry comprising a conductor thickness of at least 2.0 oz/ft².

9. The LED light bulb of claim 6, further comprising a screw and a backing plate that affixes the flexible circuitry to the shell.

10. The LED light bulb of claim 6, the shell comprising one or more repositionable segments.

11. The LED light bulb of claim 10, further comprising an actuator that repositions the segments.

12. The LED light bulb of claim 11, further comprising electronics that control the actuator.

13. The LED light bulb of claim 12, the electronics comprising an orientation sensor for determining orientation of the LED light bulb, wherein the electronics reposition the segments based upon the orientation.

14. The LED light bulb of claim 6, further comprising one or more caps that cover the one or more LEDs within the apertures.

15. The LED light bulb of claim 14, the one or more caps comprising a phosphor.

16. The LED light bulb of claim 14, the one or more caps comprising a lens portion that spreads light from the one or more LEDs.

17. The LED light bulb of claim 6, the shell forming one or more additional apertures through which the one or more LEDs do not emit light, to promote convection through the shell.

18. The LED light bulb of claim 6, wherein the power connections provide an input voltage of 100 volts or more, and the power converter transmits an output voltage of 50 volts or less to the flexible circuitry.
